(19) United States
(12) Patent Application Publication
(10) Pub. No.: US 2020/0404923 A1
(43) Pub. Date: Dec. 31, 2020

(54) HERBICIDE FORMULATION CONTAINING GLUFOSINATE, SOLID HERBICIDE FORMULATION CONTAINING GLYPHOSATE, AND, USE OF HERBICIDE FORMULATION

(71) Applicant: OXITENO S.A. INDÚSTRIA E COMÉRCIO, São Paulo - SP (BR)

(72) Inventors: Priscila Castelani, Mauá - SP (BR); Rafael Augusto Alves Ferreira, Mauá - SP (BR); Rafael Pires-Oliveira, Mauá - SP (BR); Bruna Mendonça, Mauá - SP (BR); Klaus Jurgen Baldauf, Mauá - SP (BR); Cintia Teruko Matuzawa Tancsik, Mauá - SP (BR); Britney Hebert Prestridge, Hattiesburg, MS (US); Emily Matthews Barker, Hattiesburg, MS (US)

(21) Appl. No.: 17/015,266

(22) Filed: Sep. 9, 2020

Related U.S. Application Data
(63) Continuation-in-part of application No. 14/440,441, filed on May 4, 2015, now Pat. No. 10,779,530.

(30) Foreign Application Priority Data
Nov. 7, 2012 (BR) 102012028537-1
Aug. 21, 2020 (BR) 132020017088-0

(51) Int. Cl. A01N 57/20; A01N 25/30; A01N 25/12; A01N 41/04

(52) U.S. Cl. CPC A01N 57/20; A01N 41/04; A01N 25/12; A01N 25/30

(57) ABSTRACT

The present disclosure refers to liquid and solid herbicide formulations containing glyphosate and glufosinate salts in high concentrations comprising surfactant compositions. In addition to containing one or more amphoteric surfactants of the trialkyl ammonium propanoate class, the surfactant composition of the present disclosure may include other surfactants and a hydrotrope that combines synergistically with the amphoteric surfactant. The surfactant composition has been shown to be compatible with several glyphosate and glufosinate salts and has promoted stabilization and easy processing of high herbicide concentrations with advantages in the agronomic efficacy of these formulations.

### CROSS REFERENCE TO RELATED APPLICATIONS

The present application is a continuation in part of U.S. patent application Ser. No. 14/440,441, filed on May 4, 2015, which is a national stage application of International Application No. PCT/BR2013/000354 filed Sep. 13, 2013, which claims the benefit of and priority to Brazilian Patent Application No. 10 2012 028537-1 filed Nov. 7, 2012. The present application also claims the benefit of and priority to Brazilian Patent Application No 13 2020 017088-0, filed Aug. 21, 2020, the entire contents of which is hereby incorporated by reference in its entirety.

### TECHNICAL FIELD

The present application relates to herbicide formulations of glufosinate salts and solid formulations of glyphosate salts in high stabilized concentrations from the surfactant composition, with no precipitation of salts common to formulations containing amphoteric surfactants, resulting in low viscosity and easy handling formulations. Other benefits of using the surfactant composition described in herbicide formulations containing glyphosate and glufosinate are noted for their superior agronomic efficacy, and low toxicity and eye irritability.

### BACKGROUND

The need for the use of herbicide formulations in agriculture is essential for increasing crop productivity and ensuring food production for a growing world population. Of all the herbicides used in agriculture to combat weeds, one of the most used is N-phosphomethylglycine, better known as glyphosate.

In a typical formulation, glyphosate acid is present as a salt, resulting from a neutralization with a base, often monoisopropylamine (MIPA), potassium hydroxide (KOH), ammonia (NH₃), monoethanolamine (MEA), triethanolamine (TEA), monomethylamine (MMA) or mixtures thereof, in order to become water soluble. After being dissolved in water, the resulting aqueous solution shows a high surface tension value and contact angle and, consequently, shows inefficient spreading capacity and, therefore, low leaf coverage, besides the slow uptake of glyphosate that decreases its agronomic efficiency. The use of surfactants reduces the surface tension of the aqueous solution containing glyphosate salt, which improves its properties including greater absorption of glyphosate by the plant.

Another commonly used broad spectrum herbicide formulation contains glufosinate as the active ingredient. As with aqueous glyphosate solutions, aqueous glufosinate solutions have high values of surface tension and contact angle, making the use of surfactants indispensable.

However, the water solubility of surfactants can be hindered when the electrolyte concentration is too high, which is expected in formulations with a high concentration of glufosinate. Thus, the use of other components, such as hydrotropes, may be necessary.

Hydrotropes are compounds that help the solubilization of hydrophobic molecules in water or aqueous solutions. Most common examples of hydrotropes include, but are not limited to, sodium alkylbenzene sulfonates, sodium alkylnaphthalene sulfonates, ethanol, urea and sodium hydroxyalkyl sulfonates.

One limitation for obtaining herbicide formulations with a high concentration of glufosinate is the compatibility of the surfactants with the electrolytes present in the formulation, however, it has been surprisingly verified that a combination of a hydrotrope with the amphoteric surfactant described in the parent patent is able to resist the electrolyte load present in the herbicide formulation.

Herbicide formulations containing glyphosate salts in high concentrations eventually become solid due to the small space available for solvents. These formulations typically contain about 60% to 95% by weight of the herbicide active ingredient and are in the form of powder or granules, which quickly disintegrate and dissolve or disperse in water.

Solid formulations usually contain solid components that are mixed and processed in an extruder and dried with hot air flow to form the granules. Among the components added, antifoams and inert ingredients such as: inorganic salts or other soluble or insoluble components (e.g. ammonium sulphate, sodium sulphate, sodium bicarbonate, sodium carbonate, calcium carbonate, ammonium chloride, ammonium phosphate, potassium phosphate, sodium phosphate, sodium citrate, citric acid, urea, starch, microcrystalline cellulose, nanocrystalline cellulose, gum, sugar, lactose, silica, quartz, clay, kaolin, attapulgite, bentonite, dolomite, montmorillonite, diatomaceous earth, zeolite or mixtures thereof) can be highlighted.

Solid granular herbicide formulations are preferred over powder formulations because they do not produce dust and are, therefore, safer for operators by reduced inhalation hazard. Other advantages of solid formulations compared to liquid formulations are their safety against environmental accidents, low contamination of the product package facilitating its disposal, ease to pour and ease to dose product by weight or by volume, with no need for solvent in the formulation.

The granules must have good mechanical resistance so that they do not break during transport and undergo fast dissolution when added in water. In general, this type of solid formulation has no room for inclusion of built-in adjuvants that improve the performance of the herbicide, such as the absorption rate of glyphosate by the leaf and, consequently, its agronomic effectiveness. In addition, solid surfactants display lower solubilization rate, greater extrusion force needed for the process and commonly present phase separation or demixing from the dry granule. Due to these facts, it is usually preferred to use glyphosate-containing herbicide formulations in liquid form.

However, the surfactant composition of the present invention, besides improving the properties of the aqueous solution of the herbicide for application over the leaves, still improves the disintegration and solubilization of the solid herbicide formulation containing glyphosate salts, making it faster or helping in the stabilization of the dispersion when there are water insoluble components in its formulation. In general, the following surfactants can be used in this type of formulation: ethoxylated alkyl ether, ethoxylated alkyl phosphate ether, ethoxylated alkyl phosphate ester, ethoxylated etheramine, alkylpolyglycosides, ethoxylated alkylpolyglycosides, alkyl dimethyl amine oxides, alkyl betaines, alkyl dimethyl betaines, alkyl amidopropyl amines, ethoxylated alkyl amines, ethoxylated amidoamines, alkylene oxide block copolymers, sorbitan esters, polysorbates, ethoxylated imidazolines, polysiloxane derivatives, alkyl sulfosuccinates, alkyl sulphates, alkyl aryl sulphonates, olefin sulphonates, lignosulphonates, polycarboxylates, ethoxylated tristyrylphenols, ethoxylated tristyrylphenol phosphate, and mixtures thereof.

### SUMMARY

The present disclosure refers to liquid and solid herbicide formulations containing glyphosate and glufosinate salts in high concentrations comprising surfactant compositions described in the parent application. In addition to containing one or more amphoteric surfactants of the trialkyl ammonium propanoate class, the surfactant composition of this continuation in part may include other surfactants and a hydrotrope that combines synergistically with the amphoteric surfactant. The surfactant composition of this continuation in part has been shown to be compatible with several glyphosate and glufosinate salts and has promoted stabilization and easy processing of high herbicide concentrations with advantages in the agronomic efficacy of these formulations.

Specifically, the present disclosure relates to an herbicide formulation containing glufosinate, comprising glufosinate salts and a surfactant composition comprising 5 to 50% by weight of one or more amphoteric surfactants, diluted in solvents derived from their synthesis process, in which the surfactants have the general formula (I)

R¹—(XR²)ₘ—N+(R³)(R⁴)—CH₂—CH(R⁵)—COO— (I)
where
R¹ is hydrogen or C₁₋₁₈ alkyl chain,
each X is independently an ether, thioether, sulfoxide, ester, thioester or amide bond,
each R² is independently a C₃₋₆ chain,
m is a number from 0 to 8 such that the number of carbon atoms in R¹—(XR²)ₘ is 8 to 24,
R³ and R⁴ are independently hydrogen or C₁₋₄ alkyl chains, and
R⁵ is hydrogen or methyl.

The present disclosure also provides a solid herbicide formulation containing glyphosate, comprising glyphosate salts and a surfactant composition having 5 to 50% by weight of one or more amphoteric surfactants, diluted in solvents derived from their synthesis process, in which the surfactants have the general formula (I)

R¹—(XR²)ₘ—N+(R³)(R⁴)—CH₂—CH(R⁵)—COO— (I)
where
R¹ is hydrogen or C₁₋₁₈ alkyl chain,
each X is independently an ether, thioether, sulfoxide, ester, thioester or amide bond,
each R² is independently a C₃₋₆ chain,
m is a number from 0 to 8 such that the number of carbon atoms in R¹—(XR²)ₘ is 8 to 24,
R³ and R⁴ are independently hydrogen or C₁₋₄ alkyl chains, and
R⁵ is hydrogen or methyl.

### BRIEF DESCRIPTION OF THE FIGURE

FIG. 1 shows a photograph regarding the appearance of distinct herbicide formulations, highlighting the stability conferred by the herbicide formulation of the present disclosure (sample C) compared to different herbicide formulations (sample D, E and F).

### DETAILED DESCRIPTION

The present disclosure relates to the surfactant composition described in the parent application and to new herbicide formulations containing glyphosate and glufosinate salts in high concentrations prepared from this surfactant composition.

The disclosure describes the use of surfactant composition in liquid and a solid herbicide formulation containing glyphosate and glufosinate salts in high concentrations. The amphoteric surfactants suitable for use in this disclosure are those that present the general formula (I):

R¹—(XR²)ₘ—N+(R³)(R⁴)—CH₂—CH(R⁵)—COO— (I)
where:
R¹ is hydrogen or C₁₋₁₈ alkyl chain,
each X is independently an ether, thioether, sulfoxide, ester, thioester or amide bond,
each R² is independently a C₃₋₆ chain,
m is a number from 0 to 8 such that the number of carbon atoms in R¹—(XR²)ₘ is 8 to 24,
R³ and R⁴ are independently hydrogen or C₁₋₄ alkyl chains, and
R⁵ is hydrogen or methyl.

The surfactant composition described comprises one or more amphoteric surfactants belonging to the trialkyl ammonium propanoate class and one or more solvents, which may also contain other surfactants. The surfactant composition described in this disclosure can be incorporated into herbicide formulations containing glyphosate salts neutralized by different bases, including MIPA, KOH, ammonia (monoammonium, or NH₄⁺, or di-ammonium, or di-NH₄⁺), MEA, TEA, MMA or mixtures thereof.

The surfactant composition described in this disclosure may also be incorporated in formulations containing glufosinate salts. Besides being compatible with several glyphosate salts and with glufosinate salts in different concentrations, the surfactant composition of this disclosure has shown to be able to improve the compatibility and effectiveness of these formulations.

The surfactant composition included in this disclosure may also contain other surfactants, added simply by mixing to the amphoteric surfactant described above. The most common examples are: ethoxylated alkyl ether, ethoxylated alkyl phosphate ether, ethoxylated alkyl phosphate ester, ethoxylated alkyl ether, alkylpolyglycosides, ethoxylated alkylpolyglycosides, ethoxylated imidazolines, polysiloxane derivatives, alkyl dimethyl amine oxides, alkyl dimethyl betaines, alkyl propyl amine, ethoxylated alkyl amines, ethoxylated amides, alkylene oxide block copolymers, sorbitan esters, and polysorbates.

One of the advantages of this disclosure is the ease of compatibilization of the amphoteric surfactants that present the general formula (I) with these other surfactants, because these mixtures of surfactants can lead to an even greater increase in the action of herbicide formulations containing glyphosate and glufosinate, due to a synergistic effect between them.

Furthermore, this disclosure increases the agronomic efficiency of solid herbicide formulations containing glyphosate with no need for additional tank adjuvants.

In order to increase the concentration of glufosinate in the herbicide formulation, tests were carried out with the use of other components in the formulation, including some hydrotropes. Initially, the combination of the surfactant object of this disclosure with sodium xylenesulfonate resulted in a formulation with very low stability. The same test with a betaine led to similar results.

However, unexpectedly, the surfactant composition of the present disclosure, when combined with the hydrotrope sodium isethionate, shows a synergistic effect and makes it possible to increase the concentration of glyphosate and glufosinate salts. The increase in concentration of glufosinate salt with the use of amphoteric surfactant alone is made difficult, undergoing phase separation after preparation. The use of the above-mentioned hydrotrope is fundamental to the efficiency of the formulation stability.

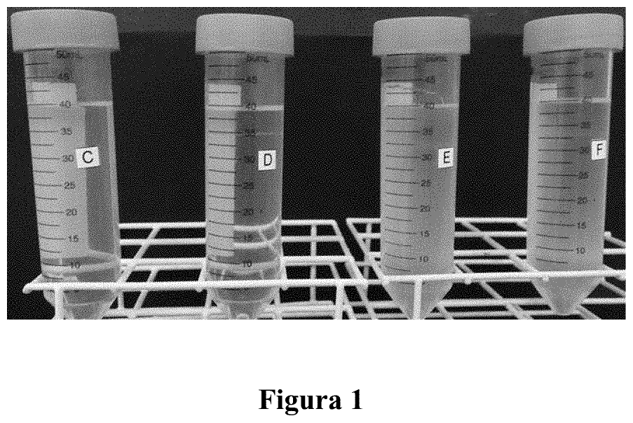

FIG. 1 shows a comparison of the stability of different herbicide formulations containing glufosinate. Specifically, sample C is the herbicide formulation prepared according to this invention, in which the surfactant composition comprises an amphoteric surfactant of general formula (I) and a hydrotrope, in which the hydrotrope is sodium isethionate.

In herbicide formulation D, the amphoteric surfactant used was a betaine, that is, different from the object of this disclosure. Phase separation can be observed in this sample D.

In sample E, the surfactant composition of the herbicide formulation containing glufosinate was prepared with another hydrotrope, more specifically sodium xylenesulfonate (SXS). This sample is found to have a turbidity, which shows the instability.

Finally, sample F was prepared from the combination of the amphoteric surfactant in sample D (betaine) and the hydrotrope in sample E (SXS). As can be seen, this sample has a cloudy appearance with imminent phase separation.

From FIG. 1, it can be seen that the herbicide formulation containing glufosinate prepared according to the present disclosure shows greater stability compared to different herbicide formulations, demonstrating the synergistic effect generated by the surfactant composition comprising the general formula amphoteric surfactant (I) and the hydrotrope sodium isethionate.

Furthermore, despite being a liquid composition containing one or more solvents, the surfactant composition described shows, surprisingly, excellent incorporation and compatibility into the solid glyphosate, easy processing of the mass in the extruder to form the granules and good mechanical resistance of the granules against breakage.

Thus, the surfactant composition according to the present disclosure shows concentrations of 5 to 50% by weight of the amphoteric surfactant of general formula (I), in other embodiments from 5 to 35%; from 0 to 20% by weight of glycol, polyol, glycerol or mixtures thereof, in other embodiments from 0 to 12%; from 10 to 70% by weight of water, in other embodiments from 20 to 50%; from 0 to 30% by weight of other surfactants, in other embodiments from 0 to 20% and from 0 to 40% by weight of other components, such as hydrotropes, in other embodiments from 20 to 30%.

In an embodiment, the herbicide formulation containing glufosinate is composed of 300 to 900 g/L of glufosinate ammonium and 200 to 600 g/L of the surfactant composition, in which the surfactant composition comprises 10% by weight of amphoteric surfactant of general formula (I), 28% by weight of sodium isethionate, 48% of water, 4.5% by weight of an alkoxylated alkyl ether and 9.5% of an antifreezing, and water in sufficient quantity (q.s.) 1 L.

In embodiments, the herbicide formulation containing glufosinate is composed by 400 to 500 g/L of glufosinate ammonium and 300 to 400 g/L of the surfactant composition.

In further embodiments, the herbicide formulation containing glufosinate comprises 420 g/L of glufosinate ammonium and 300 g/L of the surfactant composition or the herbicide formulation containing glufosinate comprises 500 g/L of glufosinate ammonium and 330 g/L of the surfactant composition mentioned above and water q.s. 1 L.

Also, in another embodiment, the herbicide formulation containing glufosinate comprises 300 to 900 g/L of glufosinate ammonium, 200 to 600 g/L of the surfactant composition, where the surfactant composition comprises 21% by weight of the amphoteric surfactant of general formula (I), 49% by weight of water, 20% by weight of a ethoxylated imidazoline and 10% by weight of a glycol, polyol, glycerol or mixtures thereof and water q.s. 1 L.

In embodiments, the herbicide formulation containing glufosinate is composed of 400 to 500 g/L of glufosinate ammonium, in other embodiments 420 g/L of glufosinate ammonium and 300 to 400 g/L of the surfactant composition, in further embodiments 300 g/L of the surfactant composition.

In general, formulations with high glufosinate concentrations are not stable, however, as demonstrated in FIG. 1, the combination presented in the present disclosure promotes a good stabilization, without common phase separation being observed in solutions with high electrolyte concentrations.

In another embodiment, the surfactant composition comprising the amphoteric surfactant of general formula (I) is used in the preparation of glyphosate-containing solid herbicide formulations. Solid herbicide formulations comprise 600 to 950 g/kg in acid (a.e.) equivalent of monoammonium glyphosate salt, in other embodiments 700 to 850 g/kg a.e.; 20 to 300 g/kg of one of the surfactant compositions described in the disclosure, in other embodiments 50 to 200 g/kg; and ammonium sulphate or other inert components q.s. 1 kg.

### Examples of Embodiments

The examples that will be presented illustrate the potential of herbicide formulations including surfactant composition according to this disclosure.

This disclosure includes surfactant compositions (Table 1) used in herbicide formulations containing glufosinate salts in high concentrations with determination of shelf life at different temperatures and other properties (Table 2).

TABLE 1
Examples of surfactant compositions of the disclosure for
use in herbicide formulations containing glufosinate salts

| | Example (composition in % by weight) | |
|---|---|---|
| Component | 1 | 2 |
| Amphoteric Surfactant | 10 | 21 |
| Hydrotrope - sodium | 28 | — |
| isethionate | | |
| Alkoxylated alkyl ether | 4.5 | — |
| Glycerol | 9.5 | 10 |
| Other surfactant - | — | 20 |
| Imidazoline ethoxylated | | |
| Water | 48 | 49 |

TABLE 2
Examples of herbicide formulations containing
glufosinate and the surfactant composition

| | | Conc. of | | | |
|---|---|---|---|---|---|
| | Glufosinate | surfactant | | Cloud | Appearance |
| | concentration | composition | Surfactant | point | after 1 month |
| Example | (g/L a.e.) | (g/L) | composition | (° C.) | at 54° C. |
| 3 | 420 | 300 | Example 1 | >90 | Clear |
| 4 | 420 | 300 | Example 2 | >90 | Clear amber |
| 5 | 500 | 360 | Example 1 | >90 | Clear |
| 6 | 420 | 300 | Hydrotrope | — | Clear |
| | | | | | colorless |
| 7 | 420 | 300 | Amphoteric | — | Biphasic |

The agronomic efficacy of the formulations has been determined via greenhouse studies and field tests with different weed species.

The experiment in the greenhouse was performed randomly, with 5 replicates per formulation, allowing for the statistical treatment of data. The spraying was done by a spray bar with 4 nozzles at 0.5 m vertical distance from the plant surface. Parameters such as travel speed, mixture volume and spray forming pressure were controlled. The applications performed in the study involved untreated plants, without application of an herbicide formulation, formulations in Examples 3 and 4, a formulation containing a hydrotrope alone and glufosinate (Example 6), and the commercially available formulation Liberty©, which comprises glufosinate at a concentration of 200 g/L. The results, observed at 14 days after application, are presented in Table 3, which shows the herbicide efficacy of the formulations in this disclosure.

TABLE 3
Greenhouse test results for herbicide
formulations containing glufosinate

Agronomic control (%)

| | Conyza | Digitaria |
|---|---|---|
| Formulation | canadensis | insularis |
| Example 3 | 75.8 a | 84 a |
| Example 4 | 70.8 a | 85 a |
| Example 6 | — | 32 b |
| Commercial | 78 a | 85 a |
| formulation | | |
| Untreated plants | 3 b | 4 c |

Results that do not share the same letter are significantly different.

The field trial was conducted at the University of Mississippi, Starkville, USA. The formulation of Example 3 was applied on a 3×12 m plot with high weed pressure. Parameters such as travel speed, mixture volume and spray forming pressure were controlled. Table 4 shows the results of the field tests performed 14 days after application with optimal results for the tested formulation.

TABLE 4
Field test results for herbicide formulation containing glufosinate

| | Agronomic control (%) | | | |
|---|---|---|---|---|
| | Amaranthus | Acalypha | Ambrosia | Conyza |
| Formulation | tuerculatus | ostryifolia | artemisiifolia | canadensis |
| Example 3 | 74.5 | 67.7 | 85 | 100 |

In another embodiment, the solid herbicide formulation containing glyphosate is composed of 720 g/kg a.e. of monoammonium glyphosate; 100 g/kg of the surfactant composition described in the disclosure (Table 5); and ammonium sulfate q.s. 1 kg. These components were mixed and processed in a 1.0 mm screen size extruder. The wet granules were dried in a fluidized bed at 60° C. for 15 min.

TABLE 5
Examples of surfactant compositions of the disclosure for
use in glyphosate-containing solid herbicide formulations.

| | Example (% by weight) | | | | |
|---|---|---|---|---|---|
| Component | 8 | 9 | 10 | 11 | 12 |
| Amphoteric | 26% | — | — | 20% | — |
| Cocamidopropyl betaine | — | 70% | — | — | 24% |
| EO/PO Copolymer | — | 30% | — | — | — |
| Ethoxylated alkyl | — | — | 100% | — | — |
| imidazoline | | | | | |
| Polysorbate | — | — | — | 30% | 15% |
| Ethoxylated alkyl | — | — | — | 5% | 5% |
| ethers | | | | | |
| Water | 74% | — | — | 45% | 56% |

An experiment was performed in a greenhouse to determine the agronomic efficacy of the glyphosate-containing herbicide solid formulations, shown in Table 6. The objective of this study was to evaluate the agronomic efficacy of the formulations in the control of the broadleaf signalgrass (Urochloa decumbens cv. Basilisk). The experiment was conducted entirely at random, with 4 replicates. In the study, each experimental unit corresponded to a pot of 350 mL and 10 cm of diameter, filled with a commercially available substrate (Carolina soil II), which was sown with 2 g of signalgrass seeds. After seedling emergence, manual grubbing was carried out keeping 10 individual plants in each pot cultivated in the greenhouse.

TABLE 6
Examples of glyphosate-containing solid herbicide formulations.

| | Example (% by weight) | | |
|---|---|---|---|
| Component | 13 | 14 | 15 |
| Monoammonium | 720 g/kg a.e. | 720 g/kg a.e. | 720 g/kg a.e. |
| glyphosate | | | |
| Example 8 | 100 g/kg | — | — |
| Example 9 | — | 100 g/kg | — |
| Example 10 | — | — | 100 g/kg |
| Ammonium sulphate | q.s. 1 kg | q.s. 1 kg | q.s. 1 kg |

The glyphosate-containing solid herbicide formulations were applied using a stationary sprayer installed in a closed environment with displacement speed control (3.6 km/h) and constant working pressure (150 kPa) pressurized by compressed air. The spraying was done by a spray bar with 4 nozzles spaced 0.5 m apart and 0.5 m of vertical distance from the top of the plants. The volume of mixture used was 150 L/ha.

The experiment was performed with 3 prototypes of glyphosate-containing solid herbicide formulations, 1 commercially available and well-known standard (Roundup® WG), and 1 additional plot of untreated plants as a reference. After the application of the treatments, the experimental plots were kept in the greenhouse equipped with controlled temperature and humidity, being irrigated as needed.

At 14 days after treatment (DAT), the assessment of the phytotoxicity of the herbicide solid formulations was performed by visual comparison of treated plots with the untreated plot and the results are shown in Table 7, considering 0 for the absence of symptom and 100 for the death of the plants (SBCPD, 1995). The fresh mass was determined by collecting the aerial part of the broadleaf signalgrass and measuring their weight on a precision scale (0.001 g) and the average results are shown in Table 8.

The phytotoxicity assessment and fresh mass were submitted to analysis of variance (ANOVA), and the means compared by the t test (LSD), at 5% probability. Results that do not share the same letter are significantly different. Considering the phytotoxicity data, the higher percentages indicate higher herbicide efficacy. Regarding the fresh mass, higher values are related to the heavier plants, which have been less affected by the treatments.

TABLE 7
Phytotoxicity assessment for glyphosate-containing solid herbicide
formulations in the control of broadleaf signalgrass in greenhouse.

| Formulation | 360 g a.e./ha | 720 g a.e./ha |
|---|---|---|
| Example 13 | 99.5% a | 99.8% a |
| Example 14 | 95.3% b | 98.0% b |
| Example 15 | 40.0% d | 79.3% c |
| Commercial | 89.0% c | 99.8% a |
| formulation | | |
| Untreated | 0.0% e | 0.0% d |

TABLE 8
Results of absolute (g) and relative (%) average fresh
mass of broadleaf signalgrass treated with glyphosate-
containing solid herbicide formulations in greenhouse.

| | 360 g | 360 g | 720 g | 720 g |
|---|---|---|---|---|
| Formulation | a.e./ha | a.e./ha | a.e./ha | a.e./ha |
| Example 13 | 2.73 g | 18.2% c | 2.09 g | 14.0% c |
| Example 14 | 3.19 g | 21.3% c | 2.09 g | 13.9% c |
| Example 15 | 10.30 g | 68.7% b | 5.91 g | 39.4% b |
| Commercial | 3.98 g | 26.5% c | 2.72 g | 18.2% c |
| formulation | | | | |
| Untreated | 14.99 g | 100.0% a | 14.99 g | 100.0% a |

The results of the control of broadleaf signalgrass using the formulations of Examples 13, 14 and 15 compared to the commercial formulation show that the herbicide formulation containing monoammonium glyphosate using the original amphoteric surfactant of this disclosure showed, surprisingly, superior weed control compared to other similar amphoteric and non-ionic surfactants. Moreover, the value of fresh mass 14 DAT proves its higher agronomic efficiency, even though it is present in a comparatively lower concentration in the surfactant composition.

The granules of two herbicide compositions comprising monoammonium glyphosate and amphoteric surfactants (Table 9) were comparatively characterized and the results are presented in Table 10.

TABLE 9
Examples of glyphosate-containing solid herbicide formulations.

Example

| Component | 16 | 17 |
|---|---|---|
| Monoammonium | 720 g/kg | 720 g/kg |
| glyphosate | | |
| Example 11 | 100 g/kg | — |
| Example 12 | — | 100 g/kg |
| Ammonium sulphate | q.s. 1 kg | q.s. 1 kg |

The extrusion force values were measured using a texturometer equipment in the following experimental conditions: pre-test speed of 5.0 mm/s, test speed of 1.0 mm/s, distance of 20 mm, trigger force of 100 g, pin hole diameter of 5 mm. The measures were carried out in triplicate. The lower the extrusion force, the better the processing for granule formation. The dissolution time of the granules is an important application property, as the granules are added to the spray tank and must dissolve rapidly to be sprayed. This measurement was carried out by adding 1.0 g of granules in 100 mL of deionized water under magnetic stirring at room temperature, in triplicate. The shorter the time required for complete dissolution, the better. The contact angle of the aqueous solution indicates the covering properties of the plant leaf area. The lower the contact angle value, the greater the potential for the aqueous herbicide formulation solution to spread and cover a larger leaf area. These measurements were performed at room temperature on a standard Parafilm substrate to ensure comparison between samples, placing one drop of volume 5.0 μL using a needle with a diameter of 0.91 mm. After 10 s of the drop deposition, the measurement was performed using the Laplace Young fitting. Another important property of these compositions is the lower generation of persistent foam after dissolution in aqueous solution. The value of persistent foam was determined according to Brazilian Standard ABNT NBR 13451:2016. In this test, the lower the persistent foam value, the better.

TABLE 10
Results of characterization of granules produced with
glyphosate-containing solid herbicide formulations.

| | Extrusion | Dissolution | Contact | Persistent |
|---|---|---|---|---|
| | force | time | angle | foam |
| Example 16 | 30.7 N | 45.0 s | 65.7° | 3.8 cm |
| Example 17 | 36.4 N | 51.7 s | 59.8° | 5.0 cm |
| Commercial | 38.1 N | 70.3 s | 76.3° | 4.0 cm |
| formulation | | | | |

The characterization results of the granules of solid herbicide formulations comprising monoammonium glyphosate show that the original amphoteric surfactant of this disclosure, unexpectedly, performs much better than other similar amphoteric formulations. The herbicide composition including the amphoteric surfactant described in this disclosure has the lowest extrusion force value for processing of the monoammonium glyphosate herbicide formulation mass. In addition to the easier production of the solid herbicide granules containing glyphosate, these granules have the shortest dissolution time, the lowest value of persistent foam, and a contact angle lower than the commercial benchmark product, allowing a good coverage of the leaf area and, consequently, enhanced weed control and agronomic efficiency.

1. An herbicide formulation containing glufosinate, comprising glufosinate salts and a surfactant composition comprising 5 to 50% by weight of one or more amphoteric surfactants, diluted in solvents derived from their synthesis process, in which the surfactants have the general formula (I)
R¹—(XR²)ₘ—N+(R³)(R⁴)—CH₂—CH(R⁵)—COO— (I)
where
R₁ is hydrogen or C₁₋₁₈ alkyl chain,
each X is independently an ether, thioether, sulfoxide, ester, thioester or amide bond,
each R² is independently a C₃₋₆ chain,
m is a number from 0 to 8 such that the number of carbon atoms in R¹—(XR²)ₘ is 8 to 24,
R³ and R⁴ are independently hydrogen or C₁₋₄ alkyl chains, and
R⁵ is hydrogen or methyl.

2. The herbicide formulation containing glufosinate according to claim 1, wherein the surfactant composition further comprises between 0 and 40% by weight of a hydrotrope.

3. The herbicide formulation containing glufosinate according to claim 2, wherein the surfactant composition contains between 20 and 30% by weight of a hydrotrope.

4. The herbicide formulation containing glufosinate according to claim 2, wherein the hydrotrope is sodium isethionate.

5. The herbicide formulation containing glufosinate according to claim 1, wherein the surfactant composition further comprises 0 to 30% by weight of other surfactants.

6. The herbicide formulation containing glufosinate in accordance with claim 4, wherein the other surfactants are selected from ethoxylated alkyl ether, ethoxylated alkyl ether, ethoxylated alkyl ether phosphate, ethoxylated alkyl etheramine, polyglycoside alkyl, ethoxylated polyglycoside alkyl, ethoxylated imidazolines, polysiloxane derivatives, dimethyl amine oxides, dimethyl betaine alkyl, propyl amine alkyl, ethoxylated alkyl amines, ethoxylated starch, alkylene oxide block copolymer, sorbitan esters, and polysorbates.

7. The herbicide formulation containing glufosinate according to claim 5, wherein the other surfactant is ethoxylated imidazoline.

8. The herbicide formulation containing glufosinate according to claim 1, wherein the surfactant composition additionally comprises:
from 0 to 20% by weight of glycol, polyol, glycerol or mixtures thereof, and
from 0 to 60% by weight of water.

9. The herbicide formulation containing glufosinate according to claim 1, further comprising:
from 300 to 900 g/L in acid equivalent (a.e.) of glufosinate; and
from 200 to 600 g/L of surfactant composition.

10. The herbicide formulation containing glufosinate according to claim 1, further comprising:
from 400 to 500 g/L in acid equivalent (a.e.) of glufosinate; and
from 300 to 400 g/L of surfactant composition.

11. A solid herbicide formulation containing glyphosate, comprising glyphosate salts and a surfactant composition having 5 to 50% by weight of one or more amphoteric surfactants, diluted in solvents derived from their synthesis process, in which the surfactants have the general formula (I)
R¹—(XR²)ₘ—N+(R³)(R⁴)—CH₂—CH(R⁵)—COO— (I)
where
R¹ is hydrogen or C₁₋₁₈ alkyl chain,
each X is independently an ether, thioether, sulfoxide, ester, thioester or amide bond,
each R² is independently a C₃₋₆ chain,
m is a number from 0 to 8 such that the number of carbon atoms in R¹—(XR²)ₘ is 8 to 24, R³ and R⁴ are independently hydrogen or C₁₋₄ alkyl chains, and
R⁵ is hydrogen or methyl.

12. The solid herbicide formulation containing glyphosate according to claim 11, wherein the glyphosate salts are selected from monoisopropylamine (MIPA), potassium, monoethanolamine (MEA), triethanolamine (TEA), monoammonium, di-ammonium, monomethylamine (MMA) or mixtures thereof.

13. The solid herbicide formulation containing glyphosate according to claim 11, further comprising inert agents.

14. The solid herbicide formulation containing glyphosate according to claim 11, wherein the inert agents are selected from ammonium sulfate, sodium sulfate, sodium bicarbonate, potassium phosphate, sodium citrate, urea, starch, sugar, silica, kaolin, bentonite, diatomaceous earth or mixtures thereof.

15. The solid herbicide formulation containing glyphosate according to claim 11, wherein the inert agents are selected from ammonium sulfate, sodium sulfate, sodium bicarbonate, and mixtures thereof.

16. The solid herbicide formulation containing glyphosate according to claim 11, further comprising:
from 600 to 950 g/kg acid equivalent (a.e.) of glyphosate; and
from 20 to 300 g/kg surfactant composition.

17. The solid herbicide formulation containing glyphosate according to claim 11, further comprising:
from 700 to 850 g/kg in acid equivalent (a.e.) of monoammonium glyphosate; and
from 50 to 200 g/kg surfactant composition.

18. The solid herbicide formulation containing solid glyphosate according to claim 11, wherein the solid herbicide formulation is in the form of powder or granules.

19. Spray mixtures for weed control, comprising the herbicide formulation containing glufosinate according to claim 1.

20. Spray mixtures for weed control, comprising the herbicide formulation containing glyphosate according to claim 11.
